(19) United States
(12) Patent Application Publication
(10) Pub. No.: US 2009/0302194 A1
(43) Pub. Date: Dec. 10, 2009

(54) MOLD FOR MANUFACTURING UNITARY COMPOSITE LENS

(75) Inventors: HOU-YAO LIN, Tu-Cheng (TW); SHENG-JUNG YU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/275,340

(22) Filed: Nov. 21, 2008

(30) Foreign Application Priority Data
Jun. 4, 2008 (CN) 200810302013.9

(51) Int. Cl. B28B 7/28

(52) U.S. Cl. 249/176

(57) ABSTRACT

An exemplary mold for making a unitary composite lens is provided. The composite lens includes a first lens portion, a second lens portion and a connecting portion interconnected between the first lens portion and the second lens portion. The mold includes a first molding member, a second molding member, a core insert. The first molding member and the second molding member cooperatively define a chamber with an opening therebetween. The core insert includes a base portion and a protrusion protruding from the base portion. The first molding member and the protrusion are configured for cooperatively defining a first part of the chamber for forming the first lens portion, and the second molding member and the protrusion configured for cooperatively defining a second part of the chamber for forming the second lens portion. The chamber includes a third part in communication with the first part and the second part.

### CROSS-REFERENCE TO RELATED APPLICATIONS

This application is related to commonly-assigned copending applications: Ser. No. ______, entitled “UNITARY COMPOSITE LENS” (attorney docket number US19199). Disclosures of the above-identified application are incorporated herein by reference in their entirety.

### BACKGROUND

1. Technical Field

The present invention relates to a mold for manufacturing a unitary composite lens.

2. Description of Related Art

With the development of optical imaging technology, electronic devices, such as digital cameras and mobile phones, adopting lens modules have been introduced and marketed.

Generally, a lens module includes a barrel and a lens assembly (e.g., a first and a second lenses) received in the barrel. In assembly, the first and the second lenses are sequentially placed into the barrel. Because of the parameter difference between the first and the second lenses, position/angle of the second lens may tilt relative to the first lens after the second lens coupled to the first lens. Accordingly, imaging quality of the lens module deteriorates, resulting an unsatisfactory lens module.

Therefore, it is desired to provide a new mold and a new method for manufacturing a lens assembly, which is capable of overcoming the above mentioned problems.

### SUMMARY

An exemplary mold for making a unitary composite lens is provided. The composite lens includes a first lens portion, a second lens portion and a connecting portion interconnected between the first lens portion and the second lens portion. The mold includes a first molding member, a second molding member, a core insert. The first molding member and the second molding member cooperatively define a chamber with an opening therebetween. The core insert includes a base portion and a protrusion protruding from the base portion. The protrusion is configured for insertion into the chamber through the opening, and the base portion is configured for closing the opening. The first molding member and the protrusion are configured for cooperatively defining a first part of the chamber for forming the first lens portion, and the second molding member and the protrusion configured for cooperatively defining a second part of the chamber for forming the second lens portion. The chamber includes a third part in communication with the first part and the second part.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of a unitary composite lens formed using a mold according to a first embodiment.

FIG. 2 is a schematic, cross-sectional view of a unitary composite lens formed using a mold according to a second embodiment.

FIG. 3 is an exploded, isometric view of the mold according to a first embodiment.

FIG. 4 is a partially assembled isometric view of the mold of FIG. 3, when a first molding member is attached to a second molding member.

FIG. 5 is an completely assembled, isometric view of the mold of FIG. 3.

FIG. 6 is a schematic, cross-sectional view of the FIG. 5, taken along the line VI-VI thereof.

FIG. 7 is a partially assembled isometric view of a mold in accordance with the second embodiment, when a first molding member is attached to a second molding member.

FIG. 8 is a completely assembled, isometric view of the mold of FIG. 7.

FIG. 9 is a schematic, cross-sectional view of the FIG. 8, taken along the line IX-IX thereof.

FIG. 10 is an isometric view of a mold in accordance with a third embodiment.

### DETAILED DESCRIPTION OF THE EMBODIMENTS

Embodiments will now be described in detail below with reference to the drawings.

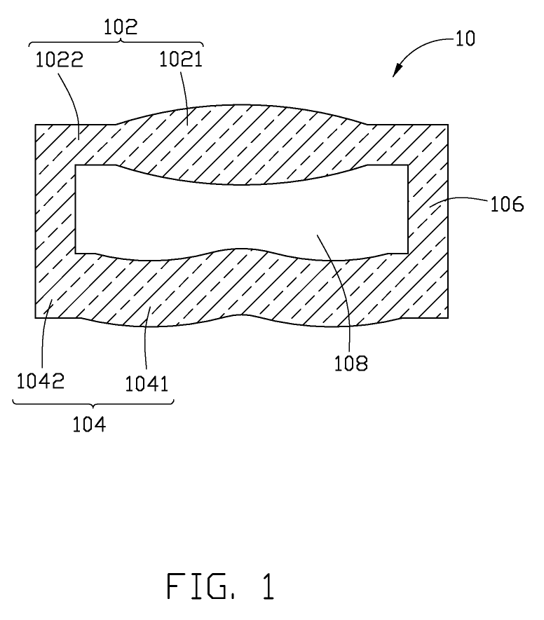

Referring to FIG. 1, the unitary composite lens 10 includes a first lens portion 102, an opposite second lens portion 104, and a connecting part 106. The unitary composite lens 10 has a gap 108 defined between the first lens portion 102 and the second lens portion 104. The first lens portion 102 includes a first active part 1021 and an inactive part 1022 surrounding the first active part 1021. The second lens portion 104 includes a second active part 1041 and an inactive part 1042 surrounding the second active part 1041. The first inactive part 1021 and the second inactive part 1041 are connected by the connecting part 106. The first lens portion 102, the second lens portion 104 and the connecting part 106 are integrally formed. The first active part 1021 is optically aligned with the second active part 1041.

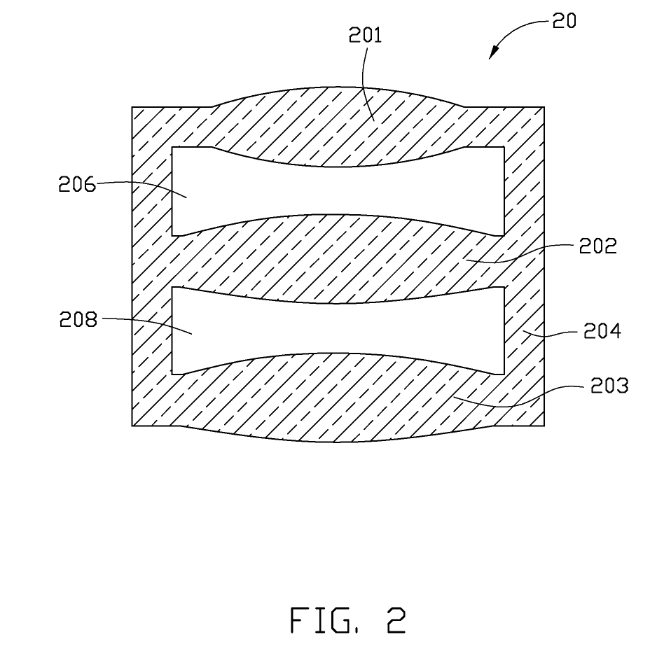

Referring to FIG. 2, a unitary composite lens 20 in accordance with a second embodiment is shown. The unitary composite lens 20 includes a first lens portion 201, a second lens portion 202, a third lens portion 203, and a connecting part 204 connecting the first lens portion 201, the second lens portion 202 and the third lens portion 203. The unitary composite lens 20 includes a first gap 206 defined between the first lens portion 201 and the second lens portion 202, and a second gap 208 defined between the second lens portion 202 and the third lens portion 203. The first lens portion 201, the second lens portion 202 and the third lens portion 203 are optically aligned with each other. The unitary composite lens 20 is similar to the unitary composite lens 10 except that the unitary composite lens 20 further includes the third lens portion 203.

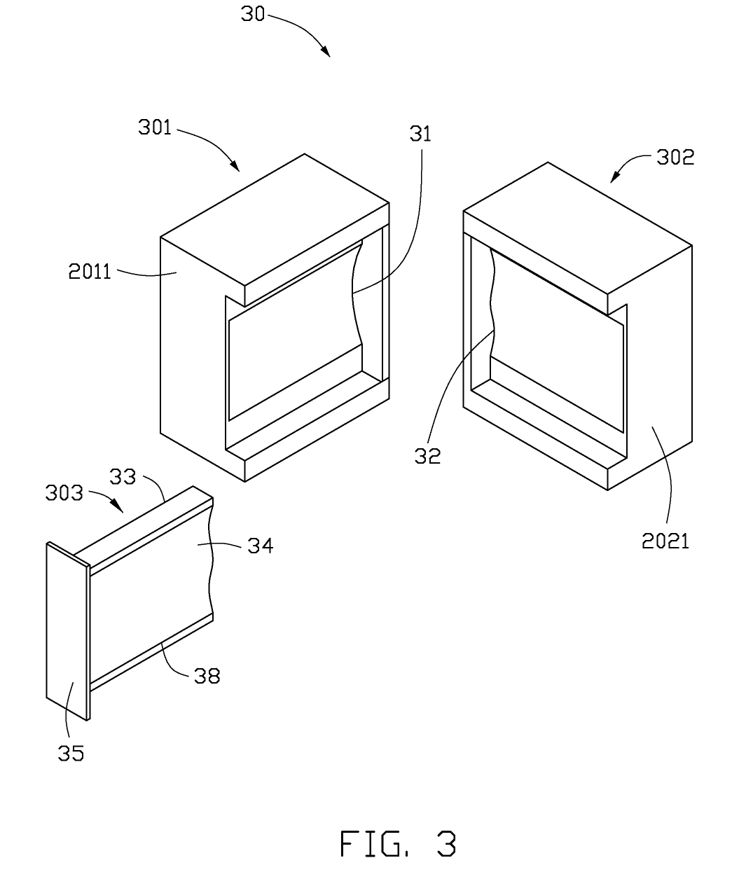

Referring to FIGS. 3-6, a mold 30 for making the unitary composite lens 10 according to a third embodiment is shown. The mold 30 includes a first molding member 301, a second molding member 302, and a core insert 303.

The first molding member 301 includes a first molding surface 31, a side surface 2011, and a rectangular opening (not labeled) defined in the side surface 2011. The second molding member 302 includes a second molding surface 31, a side surface 2022, and a rectangular opening (not labeled) defined in the side surface 2022. The first molding member 301 and the second molding member 302 are assembled together to cooperatively define a chamber 304 with an opening (not labeled) therebetween (see FIG. 3).

The core insert 303 is substantially T-shaped. The core insert 303 includes a base portion 35 and a protrusion 38 protruding perpendicularly from the base portion 35. The protrusion 38 is configured for insertion into the chamber 304 through the opening. The base portion 35 is configured for closing the opening. The first molding member 301 and the protrusion 38 are configured for cooperatively defining a first part 3042 of the chamber 304 for forming the first lens portion 102. The second molding member 302 and the protrusion 38 are configured for cooperatively defining a second part 3044 of the chamber 304 for forming the second lens portion 104. The chamber 304 includes a third part 3046 in communication with the first part 3042 and the second part 3044. The protrusion 38 includes a third molding surface 33 and an opposite fourth molding surface 34.

The shape of the third molding surface 33 and the fourth molding surface 34 is determined by the shape of the unitary composite lens 10. The distance between the third molding surface 33 and the fourth molding surface 34 equals to that between the first lens portion 102 and the second lens portion 104. It should be noted that the core insert 303 can be replaced by another core insert with a different shape depending on the shape of the lens 10.

A method for manufacturing the unitary composite lens 10 employing the mold 30 will be described in detail.

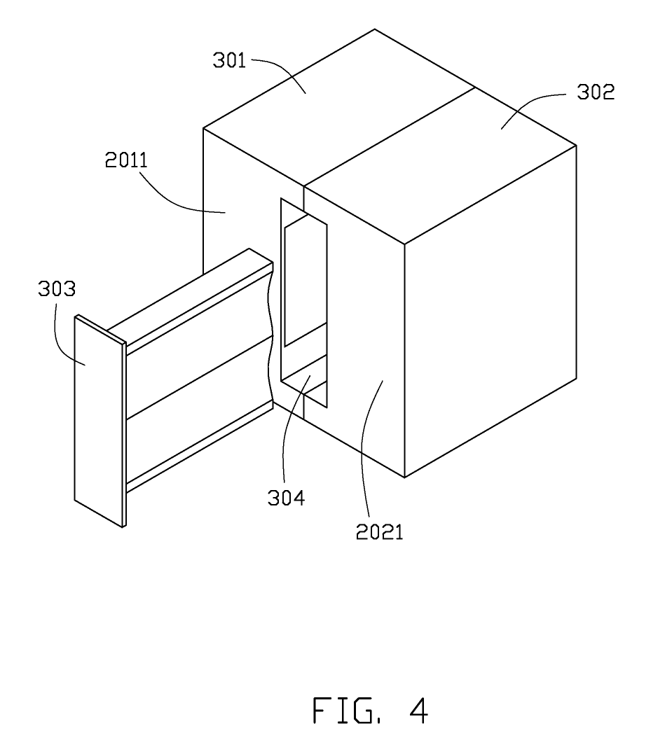

Firstly, referring to FIG. 4, the first molding member 301 and the second molding member 302 are assembled together to cooperatively define the chamber 304 with an opening (not labeled) therebetween.

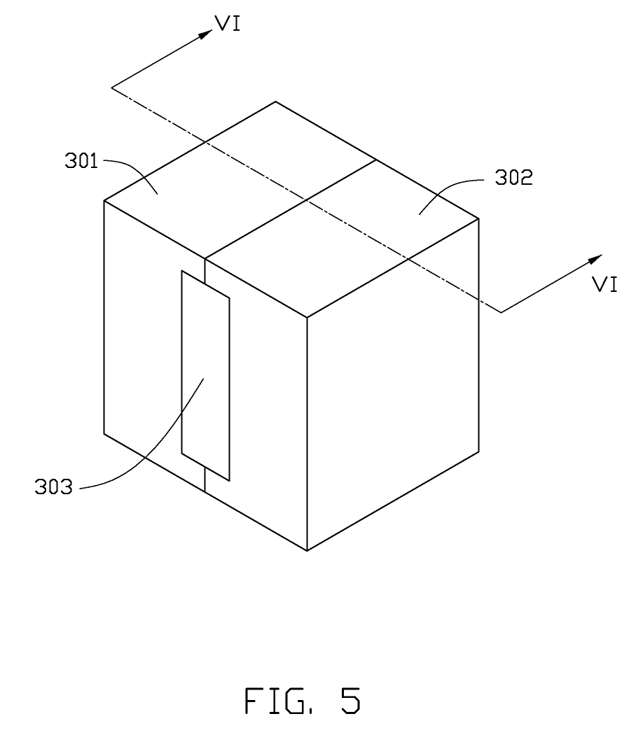

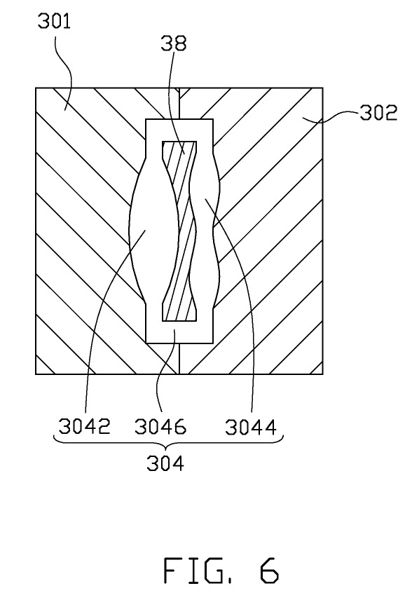

Secondly, referring to FIGS. 5-6, the core insert 303 is inserted into the chamber 304 via the opening. The shape and size of the base portion 35 matches with the opening of the chamber 304. When the protrusion 38 reaches a predetermined position in the chamber 304, a side surface of the core insert 303 is coplanar with the side surfaces 2011 and 2021. In this position, the first molding member 301, the second molding member 302 and the core insert 303 cooperatively define the chamber 304 therebetween.

Thirdly, molding material (e.g., molten resin) is injected into the chamber 304 via a runner (not shown) and a sprue (not shown) defined in the first molding member 301 or the second molding member 302.

Fourthly, the molding material is cooled.

Lastly, the core insert 303 is pulled out from the chamber 304, and then the first molding member 301 and the second molding member 302 are separated. In this way, the unitary composite lens 10 is obtained.

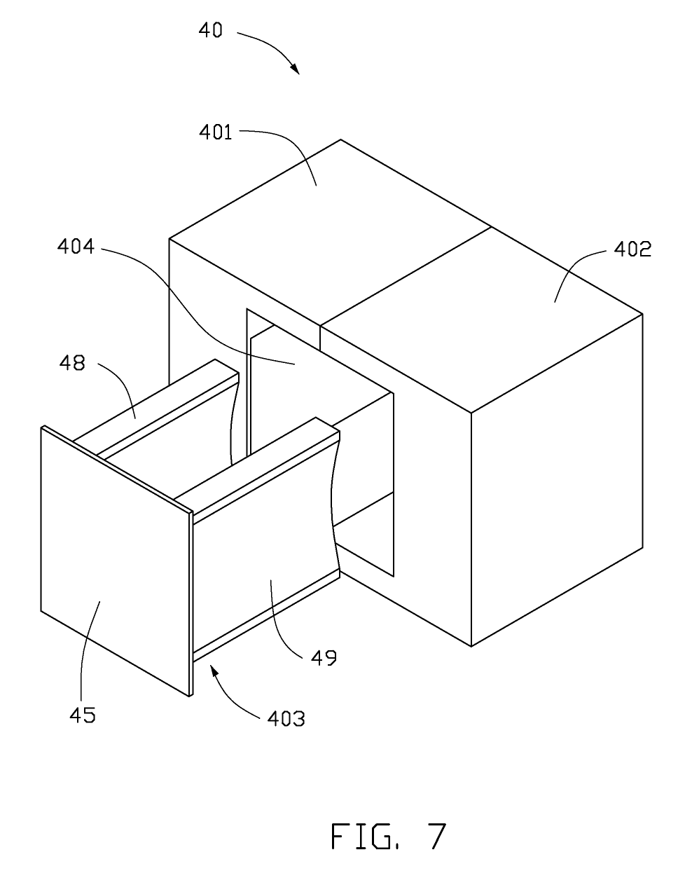

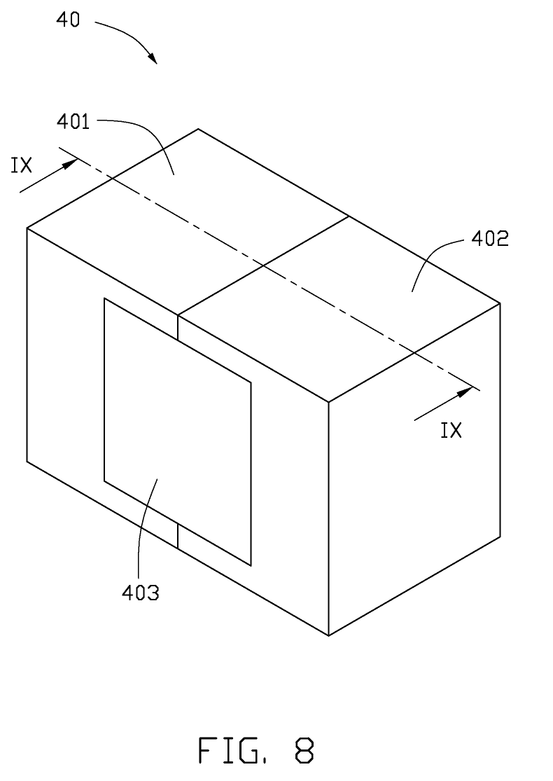

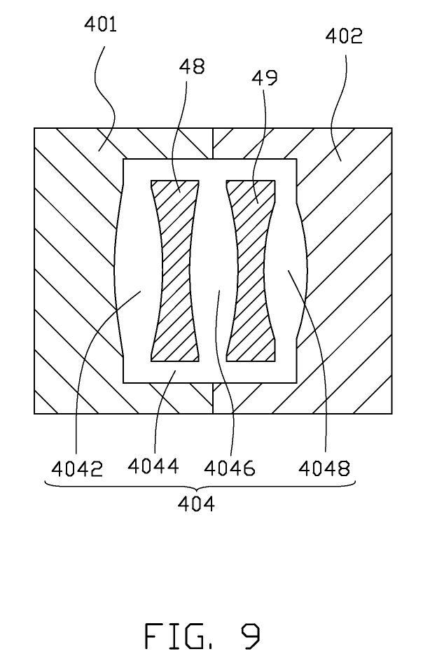

Referring to FIGS. 7-9, a mold 40 according to a fourth embodiment is shown. The mold 40 is configured for making the unitary composite lens 20 of FIG. 2. The mold 40 includes a first molding member 401, a second molding member 402, and a core insert 403. The mold 40 is similar to the mold 30 except that the core insert 403 includes a base portion 45 and two juxtaposed spaced protrusions 48, 49 extending perpendicularly from the base portion 45.

The first molding member 401 and the second molding member 402 are assembled together to define a chamber 404 with an opening (not labeled) therebetween. The first molding member 401 and the protrusion 48 are configured for cooperatively defining a first part 4042 of the chamber 404 for forming the first lens portion 201. The first protrusion 48 and the protrusion 49 are configured for cooperatively defining a second part 4046 of the chamber 404 for forming the second lens portion 202. The second molding member 402 and the protrusion 49 are configured for cooperatively defining a third part 4048 of the chamber 404 for forming the third lens portion 203. The chamber 404 includes a fourth part 4044 in communication with the first, second and third parts 4042, 4046, 4048.

It is to be understood that the core insert 403 can include more than two protrusions extending perpendicularly from the base portion 45.

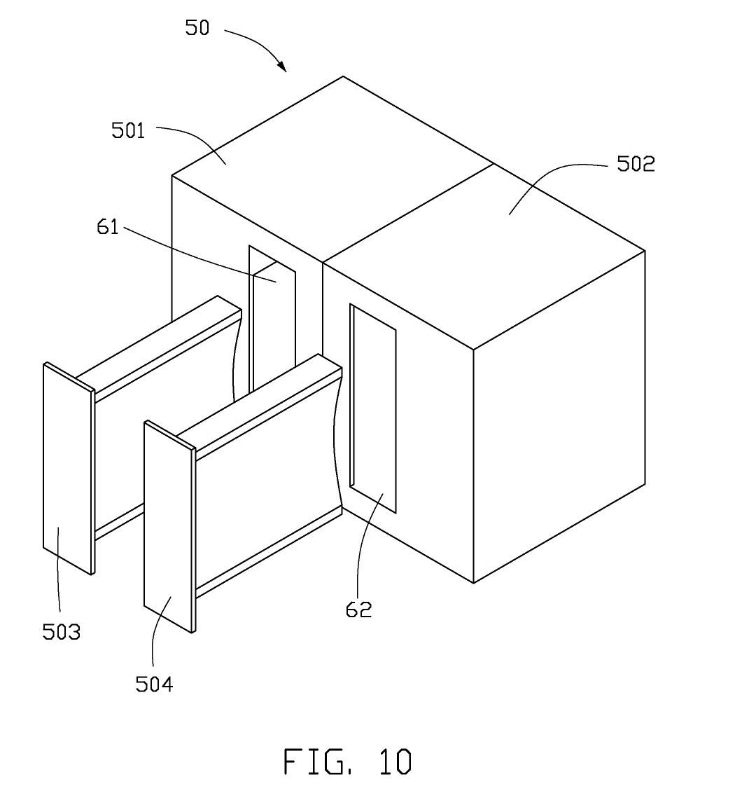

Referring to FIG. 10, a mold 50 in accordance with a fifth embodiment is shown. The mold 50 includes a first molding member 501, a second molding member 502, a first core insert 503, and a second core insert 504. The mold 50 is similar to the mold 40 except that the mold 50 includes two independent core inserts 503, 504. The first molding member 501 has a chamber 61 defined therein with an opening (not labeled) corresponding to the first core insert 503. The second molding member 502 has a chamber 62 defined therein with an opening (not labeled) corresponding to the second core insert 504. The first core insert 503 and the second core insert 504 are configured to couple with the first molding member 501 and the second molding member 502, respectively. The cross-section of the mold 50 is the same as the cross-section of the mold 40 of FIG. 7.

It should be noted that the mold 50 can include more than two core inserts, for example, a third core insert (not shown) similar to the first core insert 503.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A mold for making a unitary composite lens, the composite lens comprising a first lens portion, a second lens portion optically aligned with the first lens portion and a connecting portion interconnected between the first lens portion and the second lens portion, the composite lens having a gap between the first lens portion and the second lens portion, the mold comprising:
a first molding member;
a second molding member, the first molding member and the second molding member cooperatively defining a chamber with an opening therebetween; and
a core insert including a base portion and a protrusion protruding from the base portion, the protrusion configured for insertion into the chamber through the opening, the base portion configured for closing the opening, the first molding member and the protrusion configured for cooperatively defining a first part of the chamber for forming the first lens portion, the second molding member and the protrusion configured for cooperatively defining a second part of the chamber for forming the second lens portion, the chamber comprising a third part in communication with the first part and the second part.

2. The mold as claimed in claim 1, wherein the protrusion has a cross-section area less than that of the opening.

3. The mold as claimed in claim 2, wherein the protrusion comprises a first molding surface and an opposite second molding surface.

4. The mold as claimed in claim 1, wherein the core insert includes a T-shaped cross section.

5. A mold for making a unitary composite lens, the composite lens a first lens portion, a second lens portion, a third lens portion and a connecting portion connecting the first, second and third lens portions, the first, second and third lens portions optically aligned with each other, the composite lens having a first gap between the first and second lens portions, and a second gap between the second and third lens portions, and the mold comprising:
a first molding member;
a second molding member, the first molding member and the second molding member cooperatively defining a chamber with an opening therebetween; and
a core insert including a base portion, a first and a second juxtaposed spaced protrusion protruding from the base portion, the first and second protrusions configured for insertion into the chamber through the opening, the base portion configured for closing the opening, the first molding member and the first protrusion configured for cooperatively defining a first part of the chamber for forming the first lens portion, the first and second protrusions configured for cooperatively defining a second part of the chamber for forming the second lens portion, the second molding member and the second protrusion configured for cooperatively defining a third part of the chamber for forming the third lens portion, the chamber comprising a fourth part in communication with the first, second and third parts.

6. The mold as claimed in claim 5, wherein the first and second protrusions extend perpendicularly from the base portion.

7. A mold for making a unitary composite lens, the composite lens a first lens portion, a second lens portion, a third lens portion and a connecting portion connecting the first, second and third lens portions, the first, second and third lens portions optically aligned with each other, the composite lens having a first gap between the first and second lens portions, and a second gap between the second and third lens portions, and the mold comprising:
a first molding member;
a second molding member, the first molding member and the second molding member cooperatively defining a chamber with a first opening and a second opening therebetween;
a first core insert including a first base portion, a first protrusion protruding from the first base portion, the first protrusion configured for insertion into the chamber through the first opening, the base portion configured for closing the first opening, the first molding member and the first protrusion configured for cooperatively defining a first part of the chamber for forming the first lens portion; and
a second core insert including a second base portion, a second protrusion protruding from the second base portion, the second protrusion configured for insertion into the chamber through the second opening, the second base portion configured for closing the second opening, the first and second protrusions configured for cooperatively defining a second part of the chamber for forming the second lens portion, the second molding member and the second protrusion configured for cooperatively defining a third part of the chamber for forming the third lens portion, the chamber comprising a fourth part in communication with the first, second and third parts.

8. The mold as claimed in claim 7, wherein the first protrusion extends perpendicularly from the first base portion.

9. The mold as claimed in claim 7, wherein the second protrusion extends perpendicularly from the second base portion.
